(19) United States
(12) Patent Application Publication
(10) Pub. No.: US 2003/0127002 A1
(43) Pub. Date: Jul. 10, 2003

(54) Multilayer architechture for microcontact printing stamps

(76) Inventors: Gareth Geoffrey Hougham, Ossining, NY (US); Mary Elizabeth Rothwell, Ridgefield, CT (US); Ronald Wayne Nunes, Hopewell Junction, NY (US)

Correspondence Address: Alvin J. Riddles, Candlewood Isle, Box 34, New Fairfield, CT, 06812, US

(21) Appl. No.: 10/037,251

(22) Filed: Jan. 4, 2002

(51) Int. Cl. B41K 1/38

(52) U.S. Cl. 101/327

(57) ABSTRACT

A layered structure and process for a microcontact printing stamp has individual layers chosen to impart particular properties such as one layer chosen for surface properties and another layer chosen for bulk mechanical properties. The invention is fabricated through having a first layer with coatable properties and a subsequent layer with injectable properties resulting in a layered structure wherein the layer at the surface has optimized surface properties and is positioned on an underlying layer with carefully chosen bulk mechanical properties, and other unique functional properties can be imparted through an intermediate layer. A fabrication process is provided that employs a coating capability for one portion, an injection capability for another property and a porosity property for still another portion.

### FIELD OF THE INVENTION

The invention is in the field of microcontact printing in the fabrication of electronic circuitry wherein a stamp member having some resilience is employed to transfer a pattern of an etching responsive material onto a substrate surface and in particular to the use of separate layers in the printing stamp structure for imparting particular properties to different parts of the stamp such as surface and bulk.

### BACKGROUND OF THE INVENTION

The technique of microcontact printing has been referred to in the art as soft lithography and may be considered as being an ultrafine resilient stamping process wherein monolayers of etchant resistant materials or seed catalysis materials are transferred onto substrate surfaces with precision and resolution.

The present state of the art is considered represented by such technical articles as: Kumer et al, App. Phys. Ltrs., 63,(14), Oct. 4, 1993, P2002-2004, titled “Features of gold having micrometer to centimeter dimensions can be formed through a combination of stamping with an elastomeric stamp and an alkanethiol “ink” followed by chemical etching”; wherein there is reported the use of an elastomeric stamp to transfer fine patterns of gold using an alkanethiol ink: and Hidber et al, Langmuir, 1996, 12, Pages 1375-1380, titled “Microcontact Printing of Palladium Colloids: Micron-Scale Patterning by Electroless Deposition of Copper”; wherein there is reported the deposition of colloids that serve as catalysts for the electroless deposition of copper.

As progress advances, needs are developing for providing a tuned surface character of the stamp member that will effectively pick up the ink to be transferred and then deposit it when the stamp member has been brought into contact with the substrate; for providing a tuned elastic modulus for reproducible resilience in the stamp member; and for providing specific stamp capabilities. Heretofore in the art the stamp members have been made of a single material, plus at times a metal backplane support and tradeoffs have been required between surface and bulk properties of the stamp material.

### SUMMARY OF THE INVENTION

The invention teaches a resilient microcontact printing stamp technology involving constructing the stamp of layers having assigned properties. For example separation of the functions of the surface characteristics and the bulk characteristics of the stamp material are achieved by providing a layered structure wherein the layer at the surface has carefully chosen surface properties and is positioned on an underlying layer with carefully chosen bulk mechanical properties, and other unique functional properties can be imparted through an intermediate layer. A fabrication process is provided that employs a coating capability for one portion, an injection capability for another property and a porosity property for still another portion.

### BRIEF DESCRIPTION OF THE DRAWINGS

FIG. 1 is an illustration of the primary considerations through depictions of the intermediate structures occurring in the fabrication of the multilayer printing stamp of the invention.

FIG. 2 is an illustration of the steps involved in the multilayer printing stamp fabrication wherein a mold housing is eliminated from the figures to provide illustrative clarity.

FIG. 3 is an illustration of the extension of the principles of the invention to permit the providing of a special function layer.

### DESCRIPTION OF THE INVENTION

In the fabrication of very finely patterned resilient stamp members that are to be used for such purposes as the printing of seed layers of metal for the plating of patterns for electronic circuitry needs are being encountered where multiple material properties not usually found in a single material would be beneficial. For example the surface of the stamp would have wettability properties optimized for wetting the liquid to be used as the seed material in the plating, while at the same time the stamp must be made structurally durable with appropriate stiffness that maintains integrity of the pattern; and further such properties as porosity in a specific location is useful for fluid reservoir capability. Frequently in the art situations arise where in a material optimization of one property operates to compromise another.

In accordance with the invention the material property consideration can be overcome by providing stamps with layers each having a desired individual property such as would be the situation with a bilayer stamp. In such a situation a very thin region comprising the raised relief patterned features of the stamp is made in one material optimized for a certain set of properties, while the bulk of the stamp can be made of a second material with other properties. The materials with different properties can conveniently be fabricated as layers applied as separate steps.

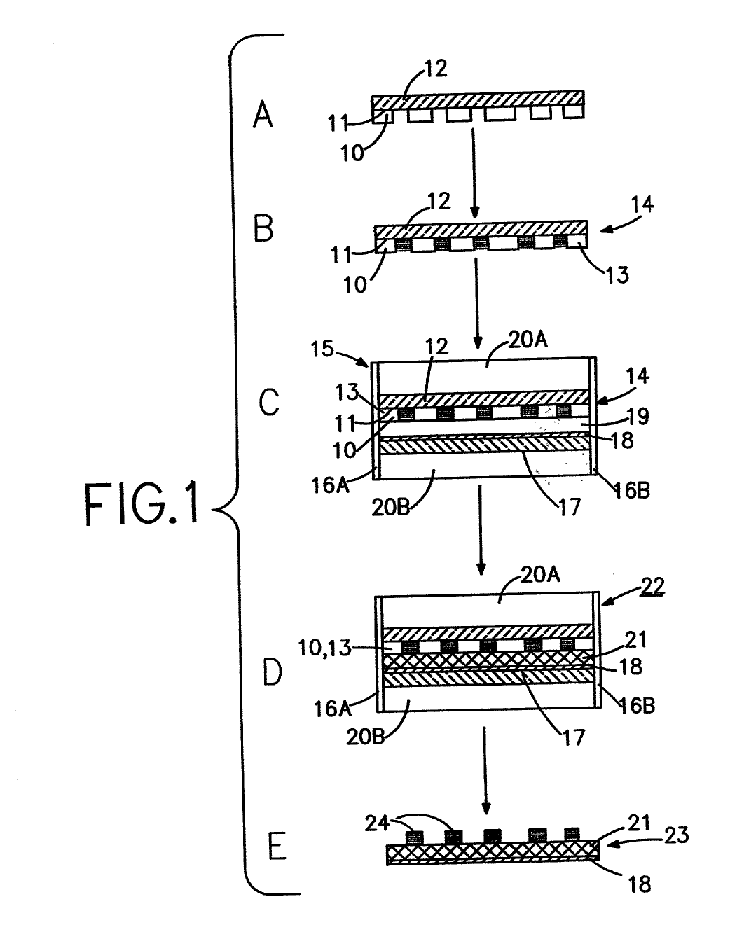

As an illustration of the primary considerations involved in the fabrication of the bilayer microcontact printing stamp of the invention a flow chart type depiction is provided in FIG. 1 of the intermediate structures in the assembly of a surface layer, a bulk layer and a backplane.

Referring to FIG. 1 the flow chart has items A through E which are depictions of intermediate structures produced in the fabrication of the stamp of the invention. At item A a mold master pattern structure is produced in which a relief pattern 10 of the ink transfer pattern of the stamp to be produced, hereinafter referred to as the pattern, is formed on a surface 11 of a supporting substrate 12. The substrate 12 has the properties of imparting stiffness, flatness and permitting adherence by the pattern. The material glass is generally satisfactory.

The pattern 10 is formed by standard lithographic techniques on the surface 11 in a negative relief, in which in other words, indicates that the spaces between the pattern features are to be the raised relief portions of the final stamp once made. On the surface of the pattern 10 a relatively thin layer 13 of the material that is to become the surface of the stamp is applied. The layer 13 has properties such:

that it can be applied in a thin layer such as by the technique of spinning,

that in the uncured state it centers the interstices between the embossed portions of the pattern 10,

that it can be made relatively handleable by a partial curing operation involving a mild amplitude and duration heat cycle, such that mixing does not take place with a subsequently added layer.

The material siloxane is one example of an appropriate material for layer 13. Commercially available silane material is the material known as Dow Corning Sylgard 184.

At item B the structure is given the reference designation 14. It now has the pattern 10 on the surface 11 of the substrate 12, with the interstices filled with the material of the layer 13, any excess having been removed so that the surface is made up of embossed elements of the pattern 10 and interstice elements of the material 13, hereinafter referred to as 10-13, and with the structure 14 having been subjected to a partial curing operation, so that it may now be handled for further processing.

That further processing involves, as illustrated in item C, the positioning of the structure 14 in a mold type apparatus for an injection operation. In item C the structure 14 is positioned in the mold 15 having sides such as 16A and 16D arranged such that the structure 14 is supported and surrounded.

Further in the illustration in item C, a supporting plate 17, of for example glass, is positioned in the bottom opening of the mold 15 and a relatively thin layer 18 for example of a flexible sheet metal material that will serve as a bottom surface of the being constructed stamp is placed over the plate 17. The relative positioning provides an internal gap 19 in the mold 15 between the to be surface layer 18 and the 10-13 face of the structure 14. The mold member 15 has top 20A and bottom 20B supporting, inserts. There is the capability, not shown, for injecting maternal into and filling the gap 19 of the structure of item C.

Referring to item D, the gap 19 of item C is filled with a precourser mix of a bulk producing material 21 that will, on curing such as with appropriate temperature cycle, impart the bulk structural properties of the being constructed stamp and cause the optimized adhesion properties of the material 13 to adhere to the bulk material 21. A satisfactory material for the precourser mix is a fluid solution of the material siloxane of which the material known as DowCorning Sylgard 186 is an example. Where the material 13 is only partially cured at the intermediate structure 14 stage, a cross reaction occurs at the interface and a superior adhesion to the material 21 in the structure in item D is achieved.

Upon curing, the structure labelled 22 is in the mold 15 ready for removal of the top 20A, bottom 20B and sides labelled 16A and 16B as in the illustration item D. The intermediate structure 22 includes the glass substrate 12 layer, the interstices filled pattern 10, 13 layer, the cured bulk layer 21, the surface layer 18 and the glass plate 17.

The finished stamp 23 is illustrated in item E.

After removal of structure 22 from the mold, the glass layer 17 is removed leaving exposed the surface layer 18 on one face, and on the other face, the glass layer 12 is removed along with the master pattern 10. An operation either simultaneously with removal of the glass layer 17 or etching is conducted at the 10-13 surface, removing the embossed portions of the master 10 and exposing a positive relief siloxane element pattern 24, each element of which is adhering the optimized adhesion properties to the bulk siloxane body 23.

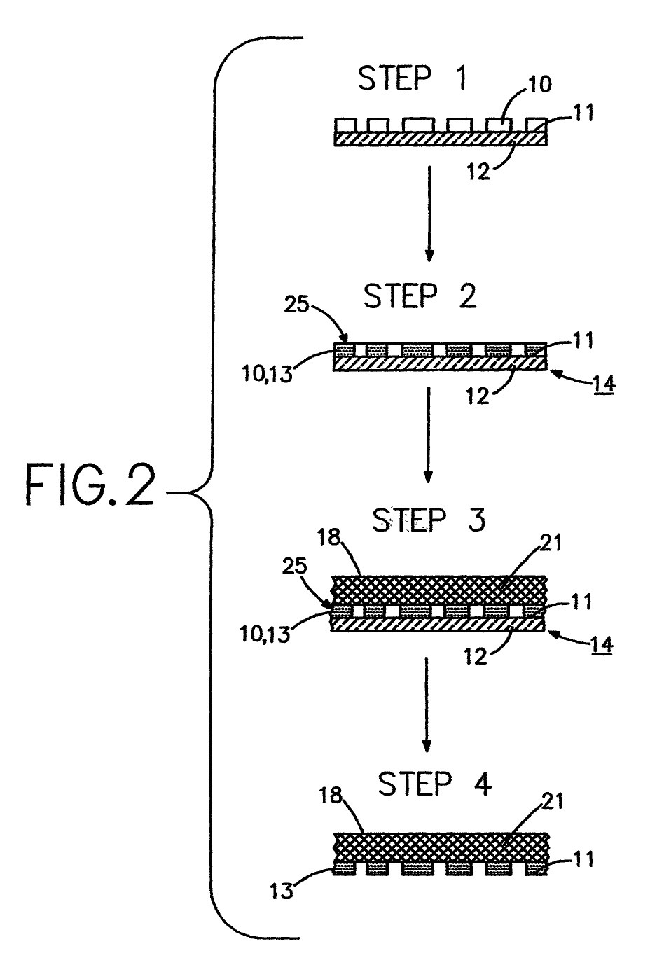

In FIG. 2 an illustration is provided of the intermediate structures produced in the multilayer printing stamp fabrication of the invention wherein a mold housing is eliminated from the figures to provide illustrative clarity for the specific functional steps. The same reference numerals as in FIG. 1 as appropriate are used.

Referring to FIG. 2 the flow chart has steps 1 to 4 which are depictions of intermediate structures produced in the fabrication of the stamp of the invention. At step 1, the negative relief pattern 10 of the ink transfer pattern of the stamp to be produced, hereinafter referred to as the pattern, is formed on a surface 11 of a supporting, glass for example, substrate 12. The material of the pattern 10 may have properties that are optimized for wettability in operations after the stamp has been produced. The substrate 12 has the properties of imparting stiffness, flatness and permitting adherence by the pattern 10. The pattern 10 is a negative relief which is that the spaces between the pattern features are to be the positive embossed portions of the final stamp. The pattern may be formed by standard lithographic techniques on the surface 11 of the substrate 12.

In step 2, over the surface of the pattern 10 a relatively thin quantity of material 13 that is to become the surface of the stamp, is applied in an uncured state such as by spinning and possibly followed by squeegeing to remove excess and to force the material 13 into the interstices between the embossed portions of the pattern 10 so as to form the layer labelled 10-13. The structure is then made relatively handleable by a partial curing operation involving a mild amplitude and duration heat cycle, such that mixing does not take place with a subsequently added layer. The structure is labelled 14 and the surface of the 10-13 layer is labelled 25.

In step 3 the material that is to be the bulk of the stamp is applied on the surface 25.

Referring to step 3, a quantity of a material that will provide the bulk stiffness of the completed stamp is applied to the surface 25 as a relatively thick layer corresponding to previously discussed layer 21 using a technique such as injection molding. The layer 21 is then covered with a thin layer for handling and overall shape retention, labelled 18.

The completed stamp is produced through step 4.

Referring to step 4 the stamp is removed from the substrate 12 by peeling along the surface 11 leaving exposed the layer 10-13. The layer 10-13 may be subjected to an etching operation that removes the negative elements of the pattern 10 and leaves remaining the positive relief of elements of 13 that occupied the interstices of the pattern; or the pattern 10 sticks to the glass of surface 11 and is simultaneously peeled away from the stamp.

The principles of the invention can be extended to permit the providing of a special function layer in the stamp.

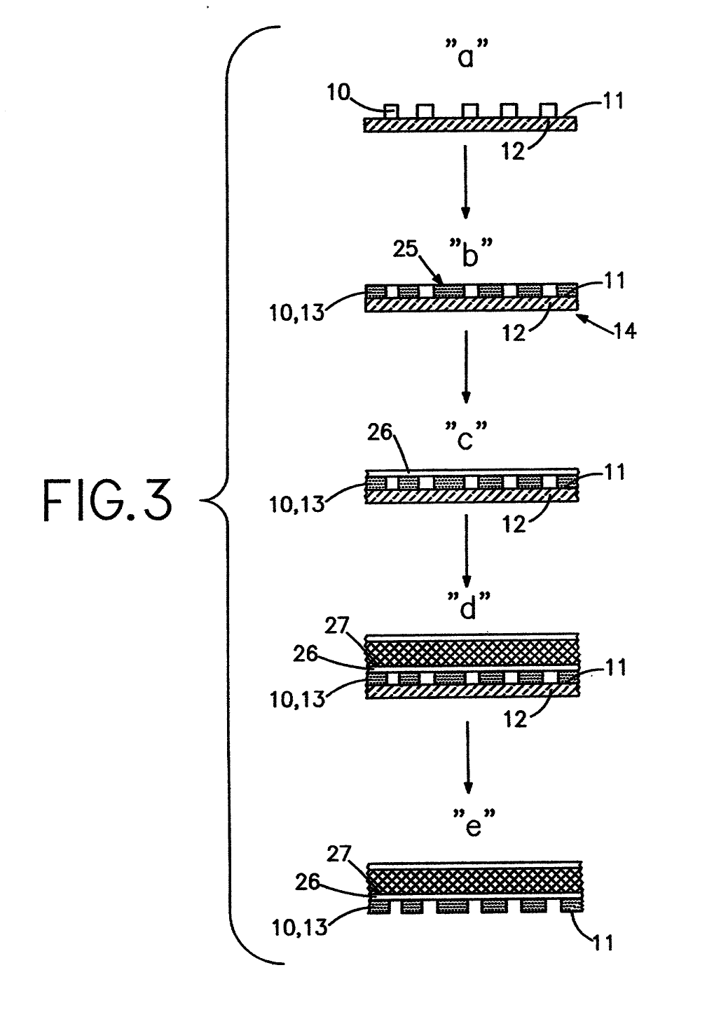

FIG. 3 is an illustration of the extension of the principles of the invention to multi layer structures such as the providing of an intermediate layer to act as an ink reservoir or serve as a gradient layer to change between extreme differences in properties from that required for the surface and the bulk.

Referring to FIG. 3 a procedure is illustrated similar to the procedure of FIG. 2 and including an added layer capability. The same reference numerals as in previous figures are used where appropriate

In FIG. 3 the procedure has stages “a” to “e” which are depictions of intermediate structures produced in fabrication. At “a” the negative relief pattern 10 is formed on a surface 11 of a supporting, glass for example, substrate 12. The material of the pattern 10 may have properties that are optimized for wettability in operations after the stamp has been produced. The substrate 12 has the properties of imparting stiffness and flatness and permitting adherence by the pattern 10. The pattern 10 is a negative relief which is that the spaces between the pattern features are to be the positive relief embossed portions of the final stamp. The pattern may be formed by standard lithographic techniques on the surface 11 of the substrate 12.

At “b”, over the surface of the pattern 10 a relatively thin quantity of material 13 that is to become the surface of the stamp in an uncured state, is applied such as by spinning followed by squeegeing, to remove excess and to force the material 13 into the interstices between the embossed portions of the pattern 10 so as to form the layer labelled 10-13. The structure is then made relatively handleable by a partial curing operation involving a mild amplitude and duration heat cycle, such that mixing does not take place with a subsequently added layer. The structure is labelled 14 and the surface of the 10-13 layer is labelled 25.

At “c”, over the surface 25 a relatively thin quantity of a material 26 that is to have a selected property such as for example porosity which property permits serving as an ink reservoir in the stamp.

At “d” over the surface of the material 26 a relatively thick layer of a material capable of providing bulk properties is applied such as by injection done in connection with FIG. 2.

The completed stamp is at “e”.

Referring to “e” the stamp is removed from the substrate 12 by peeling along the surface 11 leaving exposed the layer 10-13. The layer 10-13 is then subjected to an etching operation if necessary that removes the negative elements of the pattern 10 and leaves only remaining the positive relief of elements of 13 that occupied the interstices of the pattern and that will carry the transfer ink of the stamp.

What bas been described is a technique of stamp fabrication wherein multiple layers are employed and each provides an independent property.

What is claimed is:

1. In microcontact printing wherein an electronic circuitry pattern on the surface of an elastomeric stamp member is operable in a transfer of a further processing responsive material, to a surface of a substrate,
the improvement comprising:
said elastomeric stamp member having a surface region of a material imparting to said stamp member at least one of the properties of adhesion and wettability enhancement of the material of said circuitry pattern to said surface region, and,
said elastomeric stamp member further have at least one subsurface region, each said subsurface region being of a material imparting a particular physical property to said stamp member,

2. The microcontact improvement of claim 1 wherein said at least one subsurface region, is a single region that imparts the bulk property of stiffness to said stamp member.

3. The microcontact improvement of claim 1 wherein said at least one subsurface region, is a single region that imparts the hulk property of wettability enhancement to said stamp member.

4. The microcontact printing improvement of claim 2 wherein another region of said at least one subsurface regions, imparts the property of porosity, and is positioned between said surface region and said stiffness bulk property imparting region.

5. The microcontact printing improvement of claim 2 wherein another region of said at least one subsurface regions, imparts the property of porosity, and is positioned between said surface region and said wettability enhancement bulk property imparting region.

6. The microcontact printing improvement of claim 2 wherein said surface region is of the material known as Dupont Sylgard siloxane 184 and said subsurface region is of the material known as Dupont Sylgard siloxane 186.

7. A microcontact printing stamp,
comprising in combination:
a body having at least a layer imparting a bulk stiffness and flatness physical property on which there is a stamping pattern supporting surface,
a stamping pattern layer positioned on said pattern supporting surface of said body,
said stamping pattern layer including a negative relief stamping pattern in which the spaces between the features of said stamping pattern are the positive relief embossed portions of the final printing stamp,
said stamping pattern layer further being of an electronic circuitry processable material in which at least one of the physical properties of adhesion enhancement and wettability enhancement are imparted.

8. The microcontact printing stamp member of claim 7 including a further layer of a specific physical property imparting material positioned between said stamping pattern layer and said layer of bulk sniffiness and wettability enhancement physical property imparting material.

9. The microcontact printing stamp member of claim 8 wherein said physical property imparted by said layer of a specific physical property imparting material is the physical property of porosity.

10. The microcontact printing stamp of claim 7 wherein said layer of a bulk stiffness and wettability enhancement physical property imparting material, is the material known as Dupont Sylgard siloxane 186 and the material of said stamping pattern layer is of the material known as Dupont Sylgard siloxane 184.

11. The fabrication process of a microcontact printing stamp member,
comprising in combination the steps of:
providing a conductor pattern member, having first and second parallel surfaces,
said pattern member material between said first and second surfaces, being comprised of a negative relief of a conductor correlatable configuration of elements of a material processable into electronic circuitry,
said negative relief of a conductor correlatable configuration of elements having an adhesion enhancing material interspersed between conductor portions,
positioning said first surface of said pattern member on a processing substrate
providing a body portion including at least a layer of a stiffness enhancing material on said second surface of said pattern member,
separating said conductor pattern member from said processing substrate along the interface of said first surface of said pattern member and said processing substrate,
etching out the negative relief portions out of said pattern member leaving a positive relief of said conductor correlatable configuration.

12. The process of claim 11 wherein said step of providing a body portion is performed by an injection operation in a mold.

13. The process of claim 12 wherein said adhesion enhancing material is the material known as Dupont Sylgard siloxane 184.

14. The process of claim 13 wherein said layer of stiffness enhancing material is the material known as Dupont Sylgard siloxane 186.

15. The process of claim 14 including a partial curing step of the adhesion enhancing and the stiffness enhancing materials prior to the separation step.
